(19) United States
(12) Patent Application Publication
(10) Pub. No.: US 2006/0160408 A1
(43) Pub. Date: Jul. 20, 2006

(54) Intermediate element for establishing a connection between a cable and a contact element, and connector assembly

(76) Inventor: Thierry Quillet, La Milesse (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/329,707

(22) Filed: Jan. 11, 2006

(30) Foreign Application Priority Data
Jan. 18, 2005 (FR) 05 50140

(51) Int. Cl. H01R 4/26

(52) U.S. Cl. 439/439

(57) ABSTRACT

The invention relates to an intermediate element for establishing a connection between a contact element and a core of a cable, the intermediate element being in a conductive elastic material able to cooperate respectively with the contact element and the core of the cable, characterized in that the intermediate element is equipped with at least one flexible commutator riser. The invention also relates to a connector assembly comprising a contact element, a cable and an intermediate element.

### RELATED APPLICATION

The present application claims priority to French Application No. 05 50140 filed Jan. 18, 2005.

### TECHNICAL FIELD

The invention relates to the utilization of an intermediate element to establish a connection between a termination of a cable and a contact element. More particularly, the invention relates to an intermediate element disposed between the contact element and the cable termination in such a way as to maintain constant pressure and an electrical connection between the cable termination and the contact element. The invention also relates to a connector assembly comprising a contact element and an intermediate element so that a connection between the contact element and a cable housed in said contact element is assured by the intermediate element.

The invention has applications particularly in the field of aeronautical interconnections to allow a connection between an aluminum cable and a copper contact element. More generally, the invention has applications in any field necessitating the connection of the individual strands of a cable to a connection element so that the latter may assure the continuity of an electrical signal to the junction between the cable and a complementary device.

### BACKGROUND ART

In aeronautics, a significant part of the mass of an aircraft is represented by the set of cables traversing the aircraft. Using aluminum cables is known for decreasing this mass. Therefore, numerous aluminum cables are used in lieu of copper cables. However, aluminum cables remain connected to copper contact elements. These two materials are of different natures and have different physical properties. Such elements and cables are subject to significant physical constraints in terms of variations in pressure and temperature because of their in-flight use on board engines such as aircraft. Consequently, guaranteeing a permanent connection may not always be assured. In particular, because of their different expansion coefficients, it is possible in some temperatures that contact is no longer assured between the core of the cable, in aluminum, and the contact element in copper.

To solve this problem, the use of an intermediate element in a soft and conductive material, such as a silver ring, is known. The silver ring is, for example, inserted in a body of the contact element designed to receive the core of the cable. The cable core is then inserted in the silver ring. The silver ring allows contact between the copper body and the aluminum cable core to be maintained. In order to guarantee the electrical contact, the body is crimped over the cable core at the location of the silver ring. Therefore the silver ring is in tight contact with the copper body and the aluminum cable core. Crimping guarantees both an electrical and a mechanical connection. During thermal shocks, the contact pressure between the cable core and the walls of the body is maintained by the presence of the silver ring. The silver ring therefore allows transmission of the electrical signal to be promoted.

However, such a solution still necessitates the body of the contact element to be crimped onto the core of the cable to guarantee electrical contact. Electrical crimping necessitates precautions, particularly in order to ensure a sufficient pressure of the body on the core of the cable. At the same time, it is necessary to ensure that the body is not crimped too much on the cable, which would risk breaking certain strands of the cable, which would further increase the time necessary for achieving the electrical connection. Furthermore, because the ring is in a soft material, that is, softer than the material forming the contact element, it is not possible to know where the soft material flows after crimping. Therefore, one does not know exactly where the material forming the ring is distributed, while contact between the contact element and the cable must be guaranteed.

### SUMMARY OF THE INVENTION

In the invention is sought the construction of a connection device allowing the device to be free from electrical crimping between a contact element and the core of a cable before the device is connected electrically. The connection device according to the invention allows permanent and sufficient contact pressure of the contact element on the cable core, and vice versa, to be guaranteed, regardless of the materials used to make the contact element and the cable core. For example, the contact element may be in copper and the cable in aluminum. The invention allows an electrical function to be separated from the retention strength function in a connector assembly. The electrical function is achieved by the connection device according to the invention, while the retention strength function, if it is necessary, may be for example achieved by mechanical crimping and/or seal crimping at the location of a contact between the contact element and the cable sheath. The connection device according to the invention allows a permanent electrical contact between the contact element and the cable to be guaranteed.

The connection device utilized according to the invention is housed in a body of the contact element in such a way as to be disposed between an inner wall of the contact element and the cable core. The connection device is therefore in contact with, on the one hand, the contact element and on the other hand with the cable core. The connection device is equipped with one or more flexible pins that have been bent back or inclined in such a way as to jut out with relation to a wall of the connection device. Displacement of the pins, allowed by the elasticity of the material in which the connection device is made, allows contact between said pins and an adjacent element to be permanently guaranteed, the adjacent element may be the contact element or the cable core according to the embodiment examples of the invention. Therefore, through the pins, contact is guaranteed in a permanent manner between the contact element and the cable core. For example, if the contact element has an expansion coefficient that is different from the cable core, the expansion differentials between the contact element and the cable core are compensated for by the displacement of the pins of the connection device. For example, the connection device according to the invention may be in beryllium copper or any other equivalent elastic material.

Therefore, the object of the invention is the utilization of an intermediate element in a conductive elastic material to establish an electrical connection between a contact element and the core of a cable, the contact element being made from a first material, different from a second material forming the core of the cable, the intermediate element being equipped with at least one flexible commutator riser and being able to cooperate respectively with the contact element and the cable core, the intermediate element having a rigidity that is similar to that of the contact element and an expansion coefficient that is similar to that of the cable core.

The flexible riser(s) may have a displacement on both sides of an initial position. The initial position of the risers is the position after deformation to bend the risers back. The displacement of the risers allows permanent contact pressure of the contact element on the cable core to be maintained.

According to the examples of embodiment of the invention, the intermediate element utilized may also comprise part or all of the following additional characteristics:
The intermediate element is equipped on one inner wall with at least one flexible commutator riser, said commutator riser having a radial displacement with relation to a longitudinal axis of the intermediate element such that a free extremity of said commutator riser is able to come into permanent contact with the core of the cable.
The intermediate element is equipped on one outer wall with at least one flexible commutator riser, said commutator riser having a radial displacement with relation to a longitudinal axis of the intermediate element such that a free extremity of said commutator riser is able to come into permanent contact with the contact element.
The intermediate element is in beryllium copper.
The intermediate element is in the form of a ring.
The intermediate element is in the form of an open ring.

The invention also relates to a connector assembly comprising a contact element and an intermediate element at least partially housed in the contact element in such a way as to cooperate with an inner wall of said contact element, the intermediate element being in a conductive elastic material and equipped with at least one flexible commutator riser, characterized in that the contact element is in a first material different from a second material forming the core of the cable to which the contact element is designed to be connected, the intermediate element having a rigidity that is similar to that of the contact element and having an expansion coefficient that is similar to that of the core of the cable.

The flexible riser(s), by virtue of their displacement, allow permanent contact pressure of the contact element on a core of a cable housed in the contact element to be maintained.

According to the examples of embodiment of the connector assembly according to the invention, it is also possible to add the following additional characteristics:
The intermediate element is equipped, on an inner wall, with at least one flexible commutator riser, said commutator riser having a radial displacement with relation to a longitudinal axis of the intermediate element such that a free extremity of said commutator riser is able to come into permanent contact with the core of the cable.
The intermediate element is equipped, on an outer wall, with at least one flexible commutator riser, said commutator riser having a radial displacement with relation to a longitudinal axis of the intermediate element such that a free extremity of said commutator riser is able to come into permanent contact with the contact element.
The contact element is in copper, and the cable to which it is designed to be connected is in aluminum.
The intermediate element is in beryllium copper.
The connector assembly comprises a mechanical crimping area at the location of a contact area between the contact element and a sheath of the cable.

### BRIEF DESCRIPTION OF THE DRAWINGS

The invention will be better understood upon reading the following description and examining the accompanying figures. The figures are presented for indication purposes and in no way limit the invention.

FIG. 1 is a schematic representation of a connector assembly equipped with an intermediate element according to the invention;

FIGS. 2a and 2b are perspective views of two embodiments of an intermediate element according to the invention.

### DETAILED DESCRIPTION OF THE DRAWINGS

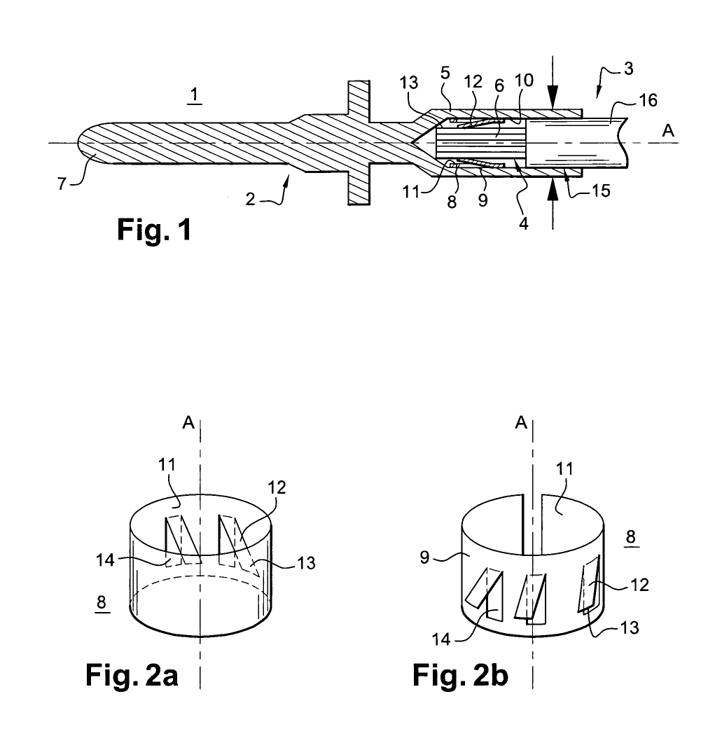

FIG. 1 represents a connector assembly 1 equipped with a contact element 2 and an intermediate element 8. An extremity 4 of a cable 3 is partially exposed in such a way that a core 6 of the cable 3 is housed in a body 5 of the contact element 2.

An extremity 7 of the contact element 2, opposite from the body 5, is formed by a male element designed for example to be housed in a complementary female element of another contact. In another example of an embodiment, it is possible that the extremity 7 is a female contact element, designed to be connected to a male contact element of a complementary connector.

In the body 5 is also housed the intermediate element 8. The intermediate element 8 has an outer wall 9 in contact with an inner wall 10 of the body 5. An inner wall 11 of the intermediate element 8 is in contact with the core 6 of the cable 3, that is, the core 6 of the cable 3 at least partially traverses the intermediate element 8.

The intermediate element 8 allows contact pressure of the body 5 on the core 6 of the cable 3 to be maintained. To do this, the intermediate element 8 is equipped with commutator risers 12 (two visible in FIG. 1) wherein a radial displacement with relation to a longitudinal axis A of the intermediate element 8 allows contact with the core 6 of the cable 3 to be maintained. Radial displacement is understood to refer to a movement of the commutator risers 12 in the direction of the longitudinal axis A of the intermediate element 8 (centripetal radial displacement) as well as in the direction opposite from the longitudinal axis A (centrifugal radial displacement).

In the example represented in FIG. 1, the risers 12 have a centripetal radial displacement in such a way as to come into contact with the core 6 of the cable 3. More precisely, a free extremity 13 of the risers 12 comes in contact with the core 6 of the cable 3. Free extremity 13 is understood to refer to the extremity of the riser 12 opposite from the extremity integral with the inner wall 11 of the intermediate element 8.

According to the examples of embodiments of the intermediate element 8, it is possible that the risers 12 form an integral part of the intermediate element 8, that is, that the risers are cut or machined on the intermediate element 8. In this case, after making the intermediate element 8 and before its utilization, the risers 12 are deformed, for example by bending, in such a way as to move them from the inner 11 or outer 9 wall, depending on the case, from the intermediate element 8. The risers 12 may then have a centripetal or centrifugal radial displacement on both sides of the initial position after deformation.

In the examples represented in FIGS. 2a and 2b, the risers 12 are machined from the body of the intermediate element 8. More precisely, windows 14 are provided on the wall 9, 11 of the intermediate element 8, the risers 12 being formed by the material cleared for constructing said windows 14. The window 14 traverses the entire thickness of the wall 9, 11 in such a way as to appear on both sides of said wall 9, 11.

It is also possible to add the risers 12 on the intermediate element 8, for example by soldering the risers to the intermediate element 8. In this case, it is possible to solder the risers at a distance from the wall 9, 11 of the intermediate element 8, in such a way that centripetal or centrifugal radial displacement of the risers 12 is possible.

In the case where the commutator risers 12 are integral with the outer wall 9 of the intermediate element 8, a direction of introduction of the intermediate element 8 in the body 5 is preferably such that the risers 12 are pinned in the direction of the outer wall 9 of the intermediate element. However, a distance between the outer wall 9 of the intermediate element 8 and the inner wall 10 of the body 5 must be sufficient for allowing a centrifugal radial displacement of the risers 12.

In the case where the commutator risers 12 in their initial position are directed towards the longitudinal axis A of the intermediate element 8, a direction of introduction of the core 6 of the cable 3 in the body 5, and therefore in the intermediate element 8, is preferably such that the risers 12 are pushed in the direction of the inner wall 11 of the intermediate element 8. If, during the utilization of the connector assembly 1, a distance between the core 6 of the cable 3 and the inner wall 11 of the intermediate element 8 increases, due to for example, expansions, the centripetal displacement of the risers 12 guarantees that contact is maintained between the intermediate element 8 and the core 6 of the cable 3 at least at the location of the free extremities 13 of the risers 12. The outer wall 9 of the intermediate element 8 being conjoined with the inner wall 10 of the body 5, the core 6 of the cable 3 therefore remains in contact with said body 5.

Generally, stresses to which the risers 12 are subjected during utilizations should not be greater than the elasticity limit of the material forming the risers 12. On the contrary, at the time of deformation of the risers 12 to obtain the initial position, it is possible to force the deformation beyond the elasticity limit.

The intermediate element 8 being made in an elastic material, the displacement of the risers 12 may have a variable amplitude, allowing in particular differential expansions between the cable 3 and the contact element 2 to be adapted when they are subjected to thermal shocks, for example.

A centripetal radial displacement of the commutator risers 12 of the intermediate element 8 according to the invention is for example between 0.05 and 0.1 mm for a body diameter of 0.8 mm, ±0.1 mm and a core diameter 6 of the cable 3 of 0.5 mm±0.1 mm.

Therefore, the displacement amplitude of the risers 12 allows the contact element 2 to be adapted to all of the conditions to which the contact element 2, in which the cable 3 is introduced, may be subjected.

No crimping is necessary to guarantee the electrical connection between the contact element 2 and the cable 3. However, in order to ensure a mechanical fixing of the cable 3 on the contact element 2, it is possible to provide a mechanical crimping at the location of an area of contact 15 between the body 5 and a sheath 16 of the cable 3. Mechanical crimping allows the cable 3 to be held in position in the body 5. In addition, this mechanical crimping may also be a seal crimping, prohibiting any penetration of outer elements such as water, sand or other element inside the body 5, therefore eliminating the risks of corrosion. Furthermore, if a mechanical crimping is performed at the location of an area of contact 15 between the body 5 and the sheath 16 of the cable 3, this would allow the wires forming the core 6 of the cable inside the body 5 to open slightly, which further increases contact between the cable 3 and the commutator risers 12.

According to different examples of embodiments of the invention, it is possible to provide more or fewer commutator risers 12.

FIGS. 2a and 2b represent two examples of different embodiments of the intermediate element 8 of the invention.

In FIG. 2a, the intermediate element 8 is a closed ring, that is, a ring having a continuous circumference. The inner wall 11 of the ring 8 is equipped with four commutator risers 12 (only two represented in FIG. 2a), regularly distributed over a circumference of the ring 8. The risers 12 have an initial position in which the risers are directed toward the longitudinal axis A of the intermediate element 8. The free extremities 13 of the commutator risers 12 are designed to rest in contact with the core 6 of the cable 3 as described previously thanks to a centripetal radial displacement.

In FIG. 2b, the intermediate element 8 is an open ring, wherein a free outer diameter may be strictly greater than a diameter of the body 5. Free outer diameter is understood to refer to the diameter of the open ring 8 when the ring is not subjected to any constraint tending in particular to close the ring or open the ring further. In order to be able to be introduced in said body 5, the open ring 8 is compacted, that is, the ring is subjected to constraints tending to diminish its outer diameter until said outer diameter is strictly less than the diameter of the body 5. The outer wall 9 of the ring 8 is equipped with six commutator risers 12 (only three are visible in FIG. 2b). The risers 12 have an initial position in which the risers are moved apart from the longitudinal axis A of the intermediate element 8. The free extremity 13 of the commutator risers 12 is designed to rest in contact with the inner wall 10 of the body 5 (FIG. 1) thanks to a centrifugal radial displacement of said risers 12.

Of course, the ring such as represented in FIG. 2a may be an open ring, and the ring such as represented in FIG. 2b may be a closed ring.

In another example of an embodiment, it is possible to use a ring 8, open or closed, equipped with commutator risers 12 on the inner wall 11, that is, that have an initial position in which the risers are directed toward the longitudinal axis A of the intermediate element 8 and with commutator risers 12 on the outer wall 9, that is, that have an initial position in which the risers are moved apart from the longitudinal axis A of the intermediate element 8. The risers 12 of the inner wall 11 are designed to come in contact with the cable 3, and the risers 12 of the outer wall 9 are designed to come in contact with the body 5.

The intermediate element 8 is preferentially an element having a circumference that is able to come in contact with the body 5 over a partial or complete circumference of said body 5. For example, the intermediate element 8 is an annulus, ring or cylindrical tube. It is also possible to construct the intermediate element 8 in the form of a plate whose radius of curvature allows introduction of said plate in the body 5.

The intermediate element 8 has, for example, an expansion coefficient that is similar to an expansion coefficient of the core 6 of the cable 3 and a rigidity that is similar to the rigidity of the body 5 of the contact element 2.

In a preferred example of embodiment of the invention, the intermediate element 8 is in beryllium copper, the contact element 2, at least at the location of the body 5, is in copper and the core 6 of the cable 3 is in aluminum. It is also possible to construct the intermediate element 8 in any conductive elastic material, such as copper, the choice of materials depends on the desired displacement amplitude for the risers 12.

The intermediate element 8 may be covered by a layer of gold, in order to, in particular, diminish the electrical contact resistance between the different elements.

1. A method for establishing an electrical connection between a contact element and the core of a cable, the contact element being constructed in a first material, different from a second material forming the core of the cable, the intermediate element comprising at least one flexible commutator riser that is able to cooperate respectively with the contact element and the core of the cable, the intermediate element having a rigidity that is similar to that of the contact element and an expansion coefficient that is similar to that of the core of the cable.

2. The method according to claim 1, the intermediate element being equipped on an inner wall with at least one flexible commutator riser, said commutator riser having a radial displacement with relation to a longitudinal axis (A) of the intermediate element such that a free extremity of said commutator riser is able to come into permanent contact with the core of the cable.

3. The method according to claim 1, where the intermediate element is equipped on an outer wall with at least one flexible commutator riser, said commutator riser having a radial displacement with relation to a longitudinal axis (A) of the intermediate element such that a free extremity of said commutator riser is able to come into permanent contact with the contact element.

4. The method according to claim 1, wherein the intermediate element is in the form of a ring.

5. The method according to claim 1, wherein the intermediate element is in the form of an open ring.

6. The method according to claim 1, wherein the intermediate element is beryllium copper.

7. A connector assembly comprising a contact element and an intermediate element at least partially housed in the contact element in such a way as to cooperate with an inner wall of said contact element, the intermediate element being in a conductive elastic material and equipped with at least one flexible commutator riser, the contact element being a first material different from a second material forming the core of the cable to which the contact element is designed to be connected, the intermediate element having a rigidity that is similar to that of the contact element and having an expansion coefficient that is similar to that of the cable core.

8. The connector assembly according to claim 7, wherein the contact element is copper, and the cable to which it is designed to be connected is aluminum.

9. The connector assembly according to claim 7, wherein the intermediate element includes an inner wall, at least one flexible commutator riser extending inwardly from the inner wall, said commutator riser having a radial displacement with relation to a longitudinal axis (A) of the intermediate element such that a free extremity of said commutator riser is able to come into permanent contact with the core of the cable.

10. The connector assembly according to claim 7, wherein the intermediate element is equipped, on an outer wall with at least one flexible commutator riser, said commutator riser having a radial displacement with relation to a longitudinal axis (A) of the intermediate element such that a free extremity of said commutator riser is able to come into permanent contact with the contact element.

11. The connector assembly according to claim 7, wherein the intermediate element is beryllium copper.

12. The connector assembly according to claim 7, wherein the assembly comprises an area of mechanical crimping at the location of an area of contact between the contact element and a sheath of the cable.
